(19) United States
(12) Patent Application Publication
(10) Pub. No.: US 2006/0227047 A1
(43) Pub. Date: Oct. 12, 2006

(54) MEETING LOCATOR SYSTEM AND METHOD OF USING THE SAME

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, Pismo Beach, CA (US)

(21) Appl. No.: 11/428,341

(22) Filed: Jun. 30, 2006

Related U.S. Application Data
(60) Provisional application No. 60/750,252, filed on Dec. 13, 2005.

(51) Int. Cl. G01S 5/14

(52) U.S. Cl. 342/357.13; 342/357.07

(57) ABSTRACT

A meeting locator system enables users, each having a mobile phone equipped with locative sensing capabilities, to receive locative data from one another. The meeting locator system displays the location of each user upon a visual map on a mobile phone of at least one user. The visual map is automatically scaled to simultaneously display the location of each user. The meeting locator system computes midpoint location (geometric or geographic) between the users and displays the midpoint over the visual map as an approximate location where the users are likely to meet. The midpoint location can be updated and further adjusted based upon an estimated travel time for each user to reach the midpoint. The estimated travel time is computed based upon a current speed of each user, a recent average speed of each user, a computation of path lengths between each user, and/or other travel conditions and is displayed.

This application claims the benefit of U.S. Provisional Application No. 60/750,252, filed Dec. 13, 2005, which is incorporated in its entirety herein by reference.

The present invention is also related to co-pending U.S. patent application Ser. No. 11/344,612, of Rosenberg, filed Jan. 31, 2006 and entitled “POINTING INTERFACE FOR PERSON-TO-PERSON INFORMATION EXCHANGE”, which is incorporated in its entirety herein by reference.

### BACKGROUND

1. Field of Invention

Embodiments exemplarily described herein relate generally to mobile units that are enabled with position locative sensing capabilities, and more specifically to methods, apparatus, and computer programs for enabling users of GPS equipped mobile units to locate each other within the physical world.

2. Discussion of the Related Art

Currently, a number of systems and technologies exit for enabling mobile phones to determine their spatial location within the physical world. For example, mobile phones have been developed that have integrated global positioning system (GPS) sensors integrated within the system such that the mobile phone can use the GPS sensors to access real-time locative data with which the current location of the phone can be determined. One such mobile phone is disclosed in U.S. Pat. No. 6,816,711, which is hereby incorporated by reference. Another such mobile phone is disclosed in U.S. Pat. No. 6,501,420, which is also hereby incorporated by reference.

As disclosed in U.S. Pat. No. 6,867,733, which is hereby incorporated by reference, two mobile units may exchange locative data with each other, either by direct messaging of locative data between the mobile units or by sending locative data to each other through an intervening networked server that maintains a locative database of mobile device locations and exchanges information with a plurality of mobile units.

Using either direct messaging or communication through an intervening server, the aforementioned prior art systems provide a basic infrastructure by which two mobile devices may exchange locative data with each other, however, it is common for people who are trying to meet up with each other in large or crowded places to call each others mobile phone and verbally plan a specific meeting location. For example, two people who are trying to meet up within a large and crowded beach might engage in a mobile phone call and verbally agree to meet at the lifeguard stand as a convenient means of finding each other. In many cases, the people will remain on the phone with each other as they navigate the physical distance between them, for example walking across an expansive parking lot of an amusement park while verbally describing landmarks they pass as a means of honing in on each others location. In some cases, the two people will verbally pick a landmark that they believe approximately midway between them, hang up the phone, and then each head to the landmark. Often the landmark that they believe is midway between them is substantially closer to one person than the other, resulting in one person reaching the landmark first and waiting while the other person keeps moving to traverse the distance. This is a waste of time.

Even with the use of mobile phones to enable verbal communication between two people, it is still often difficult for the pair to find each other within a large or crowded environment. This is because the each of the two people often lack a clear understanding of their relative location with respect to the other, despite the verbal communications that pass between them, and despite locative data that is passed between two mobile phone users. Similarly the two people often are unable to accurately plan a meeting location that is substantially midway between them.

Thus, the prior art systems do not provide tools and methods that assist two users of GPS enabled mobile phones to more readily find a meeting location between them, nor does the prior art technology assist a pair of mobile phone users in more easily finding each other in a large and/or crowded environment as they travel towards each other with the goal of engaging in a face to face encounter.

Accordingly, it would be beneficial if there existed methods, apparatus, and computer programs that assist a pair of mobile phone users in finding a physical meeting location between them and converging upon that location in real time. In addition, it would be beneficial if situations could be avoided in which a meeting location is chosen by a pair of mobile phone users in advance that is substantially nearer to one user than the other and thereby results in one user reaching the location long before the other. In addition, it would be beneficial if there existed a fun, intuitive, and informative user interface for enabling a pair of mobile phone users to visually view their relative locations upon a geo-spatial map, to visually select a meeting location between them, to exchange meeting location data, and/or to visually track their relative progress and they head towards each other for a physical face to face encounter.

### SUMMARY

Several embodiments exemplarily discussed herein address the needs above as well as other needs by providing a meeting locator system and associated methods.

One embodiment exemplarily described herein can be characterized as a meeting location method that includes accessing current locative data of a first mobile unit and a second mobile unit, the locative data representing the location of each of the first and second mobile units; computing a midpoint location between the location of the first and second mobile units as represented by the current locative data of the first and second mobile units; accessing a database containing a visual map showing an environment local to both the first and second mobile units; and displaying, upon a screen of at least one of the first and second mobile units, the accessed visual map, a first icon representing the location of the first mobile unit with respect to the accessed visual map, a second icon representing the location of the second mobile unit with respect to the accessed visual map, and the midpoint location.

Another embodiment exemplarily described herein can be characterized as a meeting locator system that includes first and second mobile units each adapted to generate locative data representing its location. At least one of the first and second mobile units includes a display screen and circuitry. The circuitry is adapted to access current locative data of the first mobile unit and the second mobile unit; compute a midpoint location between the location of the first and second mobile units as represented by the current locative data of the first and second mobile units; access a database containing a visual map showing an environment local to both the first and second mobile units; and display, upon the display screen, the accessed visual map, a first icon representing the location of the first mobile unit with respect to the accessed visual map, a second icon representing the location of the second mobile unit with respect to the accessed visual map, and the midpoint location.

Yet another embodiment exemplarily described herein can be characterized as a mobile phone enabled with a meeting locator feature, wherein the mobile phone includes circuitry adapted to maintain a voice phone call between a user of the mobile phone and a user of a second mobile phone unit over a wireless link; circuitry adapted to repeatedly receive a geospatial coordinate over a wireless link from the second mobile phone unit during a maintained voice phone call, the geospafial coordinate indicating a current location of the second mobile phone unit; and circuitry adapted to repeatedly display during the maintained voice call, a graphical indication of the current location of the second mobile phone unit upon a displayed geospatial image, the geospatial image representing the local geographic vicinity of both the mobile phone and the second mobile phone unit.

### BRIEF DESCRIPTION OF THE DRAWINGS

The above and other aspects, features and advantages of several embodiments exemplarily described herein will be more apparent from the following more particular description thereof, presented in conjunction with the following drawings.

FIG. 1 illustrates one embodiment of an exemplary meeting locator system;

FIG. 2 illustrates one embodiment of an exemplary mobile phone capable of being implemented in conjunction with the meeting locator system shown in FIG. 1;

FIG. 3A illustrates a screen display associated with one embodiment of the meeting locator system exemplarily illustrated in FIG. 2;

FIG. 3B illustrates a screen display associated with another embodiment of the meeting locator system exemplarily illustrated in FIG. 2; and

FIGS. 4 and 5 illustrate screen displays associated with one embodiment of the meeting locator system exemplarily illustrated in FIG. 2 in which users of the meeting locator system get progressively closer to each other.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments exemplarily described herein. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of embodiments exemplarily described herein. The scope of the invention should be determined with reference to the claims.

Generally, numerous embodiments exemplarily described herein provide a meeting locator system that enables a pair of mobile phone users to exchange locative data between their mobile phone units and uses the data to assist the users to find each other within a physical environment. For example, locative data is exchanged between a pair of users' mobile units. The locative data is displayed graphically such that each of the users can view a visual map of his or her local environment upon the screen of his or her mobile phone, the visual map including a graphical representation of the local environment of the user and a graphical representation of the other user's location within the local environment, in addition to a graphical representation of the user's own location within the local environment.

In some embodiments, the image size of the displayed visual map is scaled based upon the distance between the user's own location within the local environment and the other user's location within the local environment. In some of such embodiments, the image size of the displayed visual map is scaled such that the user's own location and the other user's location may both be displayed upon the same screen view. In some embodiments, the scaling of the geospatial view is zoomed automatically based upon the distance between the user's own location and the other user's location decreases. In this way, as the two user's approach each other within the real physical world, a visual map is displayed to the users that depicts a smaller and small area around the users, the smaller and smaller area being displayed with greater and greater levels of visual detail.

In some embodiments, an estimated travel time is computed indicating a predicted amount of time that will pass until the two users meet at an intervening location between them. The estimated travel time is computed based upon the current distance between the users and an estimation for the average travel speed of each user that is expected as they move towards each other. In some embodiments, the estimated average speed for each user is determined based upon a determined current speed and/or historical speed of motion of each user. In some embodiments, other factors are considered in the computation of the estimated travel time, such as the traffic conditions, the lengths of paths and roads that the users will follow, the mode of travel of the users, and the presence of hills, that may also affect the speed at which each user may cover the intervening distance between them. In some embodiments, a textual display of the estimated travel time is displayed upon the screen along with the view of the visual map. This estimated travel time may be useful because it provides the user with an estimation of how long will take for them to reach each other at an intervening location between them. In some embodiments, the estimated travel time is updated repeatedly as the users cover the distance between them, providing regular updates as to the remaining time expected to be required for the two users to reach each other at an intervening location.

In some embodiments, a line segment is generated (e.g., drawn) upon the visual map on the screen of a user's mobile phone, the line segment connecting the user's own location within the local environment with the location of the other uses within the local environment. In some of such embodiments, the line segment is drawn as a graphical overlay upon the geo-spatial map. In some embodiments a numerical distance between the user's own location and the other user's location is computed and displayed upon the screen along with the view of the visual map. In some of such embodiments, this distance is updated repeatedly over time as the users approach each other, indicating with each repeated update the remaining distance between the users. As the users near each other, the distance will approach zero. In this way, the users can accurately monitor their progress as they collectively cover the intervening distance. In some embodiments, the distance is computed and/or displayed one-half the distance between the users, thereby indicating an estimate of distance that each user will need to travel to meet each other (assuming both users are moving at roughly the same speed towards each other). In some embodiments, if the users are moving at different speeds, the numerical distance that will be traveled by each user prior to their meeting will be adjusted accordingly. Thus, a user who is moving faster will cover more of the intervening distance proportionally to how much faster his speed is than the slower user. In this way, a more accurate estimate of distance left to travel prior to meeting can be provided to each user.

In some embodiments, a geospatial midpoint location is computed and generated (e.g., drawn) upon the view of the visual map, the geospatial midpoint location being the geographic midpoint between the user's own location and the other user's location. In some embodiments, the geospatial midpoint location is adjusted based upon an estimated speed or average speed. In some embodiments, the estimated or average speed is based upon a current speed and/or historical speed of motion of each user. In some embodiments, other factors are considered such as the traffic conditions, the routes of paths and roads, and the presence of hills, that may also affect the speed at which each user may cover the intervening distance between them.

In some embodiments, an alert may be triggered when the intervening distance between the two users is determined to have just fallen below some threshold value. For example, if it is determined that the distance between the two users is below 20 ft, an alert may be imparted upon one or both users. This alert may be visual, audio, and/or tactile in nature.

In some embodiments, an alarm may be triggered when it is determined (or predicted) that the two users have missed each other as a result of coming within a certain distance of each other and then subsequently having the distance between them increase. Such a data profile may be automatically interpreted by circuitry supported by the mobile phone as a near miss in which the two uses passed by each other and then continued moving away from each other. To prevent the users from getting too far away from each other, an alarm is imparted upon the users. The alarm may be visual, audio, and/or tactile in nature.

In some embodiments, the aforementioned meeting locator system may be automatically turned off when it is determined that the users have come within a close certain proximity of each other for more than some threshold amount of time. For example, if it is determined that the users are within 10 feet of each other for more than 30 seconds, it may be assumed that the users have found each other within the physical space and are physically engaged. The meeting locator system may then automatically turn off or enter a sleep mode.

Numerous embodiments exemplarily described herein provide methods, apparatus, and computer programs that enable a pair of users, each using a mobile phone equipped with spatial positioning capabilities, to digitally communicate their current spatial coordinates to each other over a communication network while holding a phone conversation. Moreover, numerous embodiments exemplarily described herein enable a pair of mobile phone users, each using a mobile phone equipped with spatial positioning capabilities, to digitally communicate their current spatial coordinates to each other by sending an encoded message from each mobile phone to the other mobile through an intervening communication network or by sending data to a locative server over a communication network, the locative server passing the data received from each of the mobile phones to the other of the mobile phones. For example, embodiments exemplarily described herein provide the users of mobile phones equipped with spatial positioning capabilities with a user interface such that each user can view a graphical image that includes a map of their local environment, a graphical depiction of their own location within the mapped local environment, and a graphical depiction of the location of the user that he or she is holding a conversation with within the mapped local environment. In this way, a first user who is holding a conversation with a second user can visually review his own location relative to the mapped local environment, the location of the second user relative to the mapped local environment, and his own location relative to the location of the second user. When provided to each of a pair of phone users who are holding a conversation, this visual interface is useful when the users are trying to meet up each other within the real physical world at an intervening location between them. To further support the two users in their effort to meet at an intervening location between them, a number of additional features will be described in greater detail below.

As used herein, the phrase “mobile phone” broadly refers to any mobile wireless client device that provides person-to-person voice communication over a network. The mobile phones are also enabled to exchange non-voice data with a network and thereby exchange data with other mobile phones that are in communication with the same network. A typical mobile phone is a wireless access protocol (WAP)-enabled device that is capable of sending and receiving data in a wireless manner using the wireless application protocol. The wireless application protocol (“WAP”) allows users to access information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. As described herein, locative data may be sent between mobile phones using any one of a variety of different techniques. Embodiments described herein are not limited to mobile device users who have WAP-enabled devices or to use of any particular type of wireless network. Such devices and networks are merely illustrative; any wireless data communication technology now known or hereafter developed may be used in connection with the invention that is now described in more detail. In addition, the mobile phones are enabled with spatial positioning capability such that a geospatial location can be determined for each mobile phone, the geospatial location indicating the location of that phone within the real physical world. In many embodiments, a GPS transducer local to each mobile phone is used alone, or in combination with other locative technologies, to determine the geospatial location of that mobile phone. In some embodiments, additional sensors such as magnetometers and/or inclinometers are used to provide orientation data indicative of the spatial orientation of the mobile phone with respect to the real physical world.

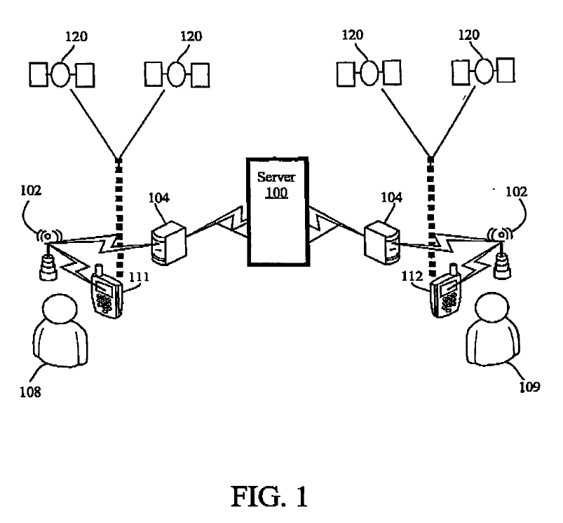

FIG. 1 illustrates one embodiment of an exemplary meeting locator system.

As illustrated in FIG. 1, a meeting locator system may be implemented as a managed service (e.g., in an ASP model) using a locative server 100, which is connected or connectable to one or more networks. For illustrative purposes, the locative server 100 is illustrated as a single machine, but one of ordinary skill will appreciate that this is not a limitation of the invention. More generally, the service is provided by an operator using a set of one or more computing-related entities (systems, machines, processes, programs, libraries, functions, or the like) that together facilitate or provide the functionality described below. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, the locative server 100 connects to the publicly-routable Internet, a corporate intranet, a private network, or any combination thereof, depending on the desired implementation environment. As illustrated FIG. 1, the locative server 100 is also in communication with a mobile service provider (MSP) 102 through a gateway, such as gateway 104.

As also illustrated in FIG. 1, a plurality of users may access a communication network by using mobile phone devices. While large numbers of mobile devices would generally be connected to the network, FIG. 1 shows, by way of example, a first user 108 using a first mobile phone 111 to communicate by voice over a network with another user 109 (e.g., a second user) using a second mobile phone 112. In this case, each of the first and second mobile phones 111 and 112 communicates with a mobile service provider 102 as a means of accessing the communication network. In addition, each of the first and second mobile phones 111 and 112 is equipped with a GPS transducer for determine a spatial location of that mobile phone with respect to the physical world. The GPS transducer in each of the first and second mobile phones 111 and 112 repeatedly determines the spatial location of that phone by repeatedly accessing data from a plurality of orbiting satellites 120. In addition, the first and second users 108 and 109 register for the service, typically by using a client machine which may be the first mobile phone 111 or some other machines such as a laptop or desktop computer. These techniques are merely representative, as any convenient technique (including, without limitation, email, filling out and mailing forms, and the like) may be used.

Also illustrated in FIG. 1 is a Global Positioning System (GPS) 120 for use in tracking the location of mobile phones such as device 111 and 112. Global Positioning System (GPS) technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar Global Positioning System (GPS) will be discussed with reference to the invention. However, other positioning systems are also contemplated for use with the present invention.

In order for GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

In order to gain orientation information, one or more additional sensors may be included within or affixed to the mobile phone. Some sensors can provide tilt information with respect to the gravitational up-down direction. Other sensors can provide orientation information with respect to magnetic north. For example, a magnetometer may be provided within the mobile phone to detect the orientation of the unit with respect to magnetic north. Because the user may hold the phone in various orientations, an accelerometer may also be provided to detect the orientation of the unit with respect to the earth's gravitational field. For example, an accelerometer may be included to provide tilt orientation information about the mobile phone in one or two axes. In some embodiment a single axis accelerometer is used that senses the pitch angle (tilt away from horizontal) that the mobile phone is pointing. In other embodiments a 2-axis accelerometer can be used that senses the pitch angle (tilt away from horizontal) that the mobile phone is pointing as well as the roll angle (left-right tilt) that the mobile phone is pointing. A suitable accelerometer is model number ADXL202 manufactured by Analog Devices, Inc. of Norwood Mass. To sense the orientation of the mobile phone with respect to magnetic north, a magnetometer is included. In one embodiment, a 3-axis magnetometer model number HMC1023 manufactured by Honeywell SSEC of Plymouth, Minn. is included. This sensor produces x, y and z axis signals. In addition, some embodiments may include a gyroscope such as a 1-axis piezoelectric gyroscope model number ENC-03 manufactured by Murata Manufacturing Co., Ltd. of Kyoto, Japan to further sense changes in orientation of the mobile phone. All of the orientation sensors may be housed within the casing of the mobile phone and be connected electronically to the microprocessor (also referred to herein as a “processor”) of the mobile phone such that the microprocessor can access sensor readings and perform computations based upon and/or contingent upon the sensor readings.

In some embodiments, a magnetometer or other orientation sensor may also be located external to the mobile phone and may communicate orientation data for the user to the mobile phone over a wireless link. For example, a magnetometer may be affixed to the user's body in a predictable manner, for example to his belt or to his shoe, and may communicate orientation information for the user to the mobile phone over a Bluetooth wireless connection. Such a configuration enables the mobile phone to have orientation information about the user, for example indicating the direction the user is facing, regardless of how he or she is holding the mobile phone. In such embodiments, the mobile phone may receive information about user facing direction even when the phone is at an unpredictable orientation such as when it is stored within a user's pocket haphazardly.

In some embodiments, the orientation information transferred is not from a magnetometer or other orientation sensor within the phone but is from an external orientation sensor upon the person of the user as described previously. In this way, the orientation sensor data transferred may reflect the facing direction of the user regardless of whether or not the phone is being held in a predictable manner.

Thus, as shown in FIG. 1, first and second users 108 and 109 may engage in a phone conversation using common mobile phone technologies. In addition, first and second mobile phones 111 and 112 are configured to repeatedly determine their spatial location with respect to the physical world. In addition, first and second mobile phones 111 and 112 may transmit locative data for each mobile phone to the other mobile phone (i.e., first mobile phone 111 has access to locative data representing the location of second mobile phone 112 and second mobile phone 112 has access to locative data representing the location of first mobile phone 111). This data transfer may be provided by direct messaging from phone to phone. This data transfer may be provided by locative server 100 acting to receive, store, and transmit data through a location tracking service. Either way, the processor of first mobile phone 111 is operative to repeatedly access data representing its own location within the physical world as well as locative data representing the location of second mobile phone 112 within the physical world. Similarly, the processor of second mobile phone 112 is operative to repeatedly access data representing its own location within the physical world as well as locative data representing the location of first mobile phone 111 within the physical world.

As will be described in greater detail below, circuitry supported by the first mobile phone 111 (e.g., display routines running on the processor of first mobile phone 111) uses both the location of first mobile phone 111 and the location of second mobile phone 112 to provide a visual interface with which first user 108 may more easily meet up with second user 109. Similarly, circuitry supported by the second mobile phone 112 (e.g., display routines running on the processor of second mobile phone 112) uses both the location of second mobile phone 112 and the location of first mobile phone 111 to provide a visual interface by which second user 109 may more easily meet up with first user 108. As used herein, the term “circuitry” refers to any type of executable instructions that can be implemented, for example, as hardware, firmware, and/or software, which are all within the scope of the various teachings described. The circuitry supported by the first mobile phone 111 is operative to display a repeatedly updated graphical image that includes a visual map of the environment local to the first and second mobile phones 111 and 112, a graphical depiction of the current location of first mobile phone 111 within the mapped local environment, and a graphical depiction of the current location of second mobile phone 112 within the mapped local environment. In this way, the first user 108 can visually review his own location within the mapped local environment and the location of second user 109 within the mapped local environment, thereby gaining a better understanding of his own location relative to the location of second user 109. Similarly, the circuitry supported by the second mobile phone 112 is operative to display a repeatedly updated graphical image that includes the visual map of the environment local to the first and second mobile phones 111 and 112, a graphical depiction of the current location of second mobile phone 112 within the mapped local environment, and a graphical depiction of the current location of first mobile phone 111 within the mapped local environment. In this way, the second user 109 can visually review his own location within the mapped local environment and the location of first user 108 within the mapped local environment, thereby gaining a better understanding of his own location relative to the location of first user 108. This display makes it substantially easier for first and second users 108 and 109 to meet up with each other at an intervening location between them.

In addition, circuitry supported by each mobile phone may perform computations upon both locative data representing the location of that mobile phone as well as the locative data representing the location of the other of the mobile phone it is then currently engaged in voice communication with. For example, circuitry supported by the first mobile phone 111 may compute the current distance between the first and second mobile phones 111 and 112 by subtracting the coordinate data using standard mathematical routines. This distance may optionally be displayed by circuitry supported by each or both mobile phones. In this way, first user 108 is provided with a displayed numerical value indicating the distance to second user 109. Similarly, second user 109 is provided with a displayed numerical value indicating the distance to first user 108. These values are repeatedly updated as the location of either or both of the first and second mobile phones 111 and 112 are changed. In this way, the first and second users 108 and 109 who are holding a verbal conversation may also view the distance between them. This numerical display may also make it easier for the first and second users 108 and 109 to meet up with each other at an intervening location between them.

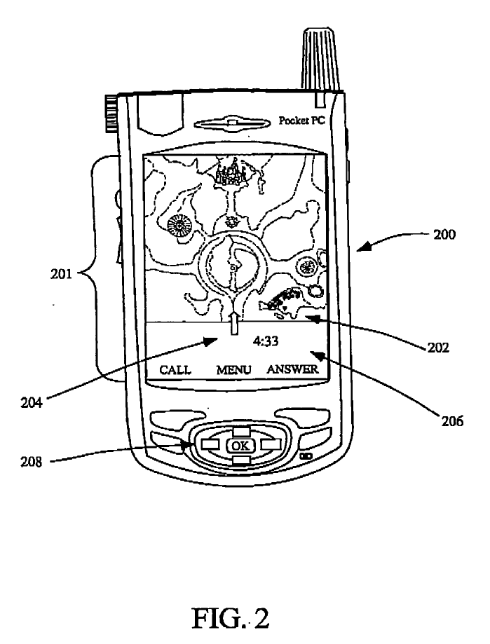

In addition, the first and second mobile phones 111 and 112 may access a geo-spatial image database supported by the locative server 100. The geo-spatial image database contains navigation-related information (e.g., geo-spatial imaging and/or mapping data, such as aerial photos, satellite photos, roadway data, exit data, and other data commonly supplied by navigation and mapping systems). For example, locative server 100 may be accessible over the internet and may retrieve navigation-related information from Yahoo Maps, Google Earth, or other mapping and/or navigation service that provides navigation-related information. In some embodiments, the navigation-related information may be downloaded and stored locally on the first and second mobile phones 111 and 112 and be updated only when the user changes his or her location substantially. In other embodiments, the navigation-related information may be downloaded regularly each time the user changes his or her location by some small increment. In many embodiments, the navigation-related information includes visual maps (e.g., geo-spatial mapping data) such that the user can view an overhead view and/or a perspective view of their current local environment in response to the accessed GPS coordinates for their current spatial position. Examples of such overhead/perspective views are discussed with respect to FIGS. 2-5.

FIG. 2 illustrates one embodiment of an exemplary mobile phone capable of being implemented in conjunction with the meeting locator system shown in FIG. 1.

As illustrated in FIG. 2, mobile phone 200 generically represents the first and/or second mobile phone 111 and/or 112 described above with respect to FIG. 1. Accordingly, mobile phone 200 contains circuitry operative to perform the above-described functionalities and may further be configured implement basic telephone features such as a dial pad (on reverse side, not shown) and a handset configuration with microphone and speaker. The mobile phone 200 also includes an information display screen 201 and a wireless communication link (not shown) to an information network such as the Internet. The mobile phone 200 also includes a differential GPS transceiver (not shown) for sensing the geographic location of the mobile phone with a high degree of accuracy. The mobile phone 200 also includes one or more orientation sensors (not shown) such as a magnetometer for sensing geometric orientation with respect to geographic north. Also, the mobile phone 200 is shaped such that it can be conveniently held and pointed in a direction while viewing the information display screen. The mobile phone 200 also includes a manual user interface 208 that may include components such as buttons, knobs, switch, levers, or touch screen areas that adapted to be engaged by a user to interact with functionality described herein.

In one embodiment, the mobile phone 200 includes a GPS receiver and a radio transmitter/receiver, e.g., transceiver, and one or more orientation sensors such as a magnetometer (not shown). The GPS receiver receives signals from three or more GPS transmitters and converts the signals to a specific latitude and longitude (and in some cases altitude) coordinate as described above. The GPS receiver provides the coordinate to circuitry supported by the mobile phone 200. The orientation sensors provide orientation data to circuitry supported by the mobile phone 200, the orientation data indicating the direction at which the mobile phone is pointing when held by the user. In general, it is assumed that the user holds the mobile phone 200 such that the displays screen 201 is in a substantially horizontal plane with respect to the ground and is aimed in a particular direction with respect to magnetic north. The direction is detected by the magnetometer and/or other orientation sensor within the mobile phone.

Based upon the detected position and orientation of the mobile phone 200, a visual map 202 of the local environment of the user is accessed and displayed upon display screen 201. In one embodiment, the visual map 202 is presented as an overhead view or perspective view such that the orientation is aligned with the direction the user is currently holding the device. In illustrated embodiment, the visual map 202 is an overhead view presented as an aerial photograph. In other embodiments, the visual map 202 may be a graphical rendition of roads, paths, and other key landmarks. The location of the user with respect to the displayed visual map 202 is generally represented by a graphical icon 204. In the illustrated embodiment, the graphical icon 204 is a small green arrow that represents the location of the user of the mobile phone with respect to the environment shown in the visual map 202, the direction of the arrow indicating the direction that the user is facing (e.g., as holding the mobile phone 200 before him or her) with respect to the environment shown in the visual map 202. If the user were facing a different direction (i.e. holding it such that it is pointing in a different direction), the arrow-based graphical icon 204 would continue to point the same way, but the visual map 202 would be presented with different imagery located ahead of the user.

Thus, the display screen 201 of the mobile phone 200 may present a visual map 202 that indicates the local environment ahead of the user in the direction the user is facing (i.e., in the direction the user is pointing the mobile phone 200), the user's location with respect to the visual map 202 represented by graphical icon 204. In addition, the display screen 201 has an information display area 206 in which other information (e.g., current time and standard user interface options) may be displayed to the user. The embodiment shown in FIG. 2 is shown before the user has implemented functionalities of the meeting locator system as exemplarily described herein.

In the embodiment particularly shown in FIG. 2, the user of mobile phone 200 is located within the Disney Land amusement park in Anaheim, Calif. Accordingly, the visual map 202 shown upon display screen 201 is an actual aerial photograph taken of the Disney Land amusement park and stored in a geo-spatial image database (e.g., a database such as that maintained by DigitalGlobe™) that contains the aforementioned navigation-related information, the photograph shown with a position and orientation such that the graphical icon 204 represents the position and orientation of the user (i.e. of the mobile phone) as he or she currently resides within the Disney Land park. Based on that which is displayed via display screen 201, the user is standing at a location approximately corresponding with the tip of the graphical icon 204 and is holding the mobile phone such that it is pointing in the direction of the green arrow. The user, looking at this image, therefore sees a view of the park from above and oriented such that if the user were to begin walking forward, he would traverse the path that is displayed.

Manual buttons and controls within the manual user interface 208 enable the user to zoom in and out of the visual map 202, giving the user differing scale images of the visual map 202 of Disney Land amusement park, wherein all images displayed such that the position and orientation of the user remains consistent with the green arrow 204. The display and zooming of images in this way, coordinated with the current GPS location and/or orientation of the user, is performed by circuitry supported by the mobile phone 200. Circuitry supported by the mobile phone 200 may be adapted from the Google Earth toolset from Google to facilitate image viewing and manipulation.

In many cases, the user of mobile phone 200 configured as described above may wish to meet up with the user of another, similarly configured mobile phone 200′ (not shown). In this example, the two users are both at the Disneyland Amusement Park (in this example embodiment) and wish to meet up at a convenient location that lies somewhere between their current physical locations. Without the meeting locator system described herein, this may be quite difficult. For example, the two users may simply engage in a conversation using conventional functionalities of their respective mobile phones to verbally settle on a place to meet, but this is unlikely to result in an ideal meeting location for the reasons described previously. Thus, the users engage the functionalities supported by the meeting locator system exemplarily described herein. The meeting locator system may be engaged when a user of one or both of the mobile phones engages a respective manual user interface. In some embodiments, the users may configure their mobile phones to automatically engage the meeting locator system whenever a phone call is placed to another user who also has a mobile phone with spatial location tracking functionality. In other embodiments, the users may configure their mobile phones to automatically engage the meeting locator system whenever a phone call is placed to another user who is within a certain physical proximity of the user. For example, if two users are determined to be within 4000 ft of each other when a phone call is initiated between them, the meeting locator system exemplarily described herein may be automatically engaged.

Upon engaging the meeting locator system, locative data (e.g., GPS coordinates) are exchanged between the mobile phone 200 of one user and the mobile phone 200′ of the other user. For example, current locative data collected by sensors on board mobile phone 200 may be transmitted to mobile phone 200′ and current locative data collected by sensors on board mobile phone 200′ may be transmitted to mobile phone 200. In this way, each mobile phone has access to locative data representing its own location within the physical environment as well as locative data representing the location of the other mobile phone within the physical environment. These two phones are currently engaged in a voice conversation over a communication network and so the locative data may be transmitted over the voice network or another data network. In general, this locative data transfer is performed repeatedly in parallel with other processes described herein. In some embodiments, the locative data transfer is performed at regular time intervals, for example every 5 seconds. In other embodiments, the locative data transfer is performed at time intervals determined based upon the speed that the transmitting mobile phone is moving (as determined by its on board GPS sensor), the faster the mobile phone is moving, the shorter the time interval. In some embodiments, the locative data transfer is performed at time intervals dependent upon the distance moved by each transmitting mobile phone device (as determined by its on board GPS sensor). For example, in one embodiment the locative data is transmitted from mobile phone 200 to mobile phone 200′ each time it is determined that mobile phone 200 has changed in position by more than 10 feet. Similarly, the locative data is transmitted from mobile phone 200′ to mobile phone 200 each time it is determined that mobile phone 200 has changed in position by more than 10 feet. In this way, locative data is transmitted only when it is necessary to update the mapping information and thereby reduces communication bandwidth burden.

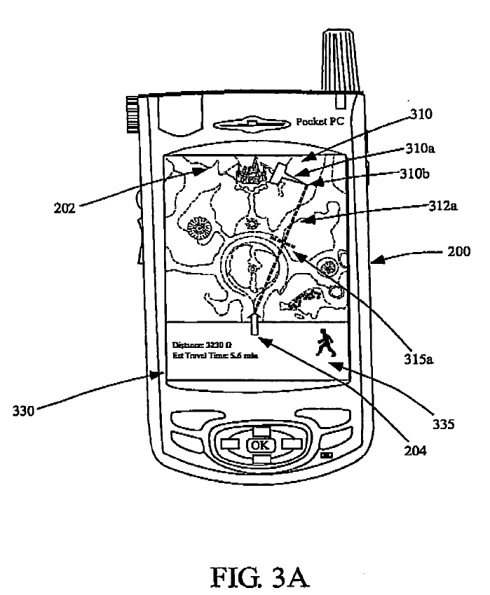

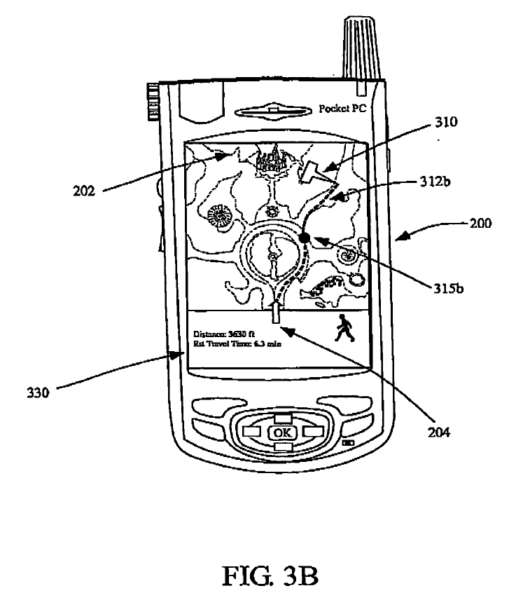

Upon receiving locative data from mobile phone 200′, circuitry supported by mobile phone 200 is operative to overlay a graphical icon (or other indicator) of mobile phone 200′ upon the visual map 202 displayed upon the screen of mobile phone 200. An exemplary embodiment of such an overlaid graphical icon is shown in FIG. 3A as a blue overlaid graphical element 310. Graphical element 310 is generated (e.g., drawn) as a graphical tab with a pointed end 310a having a tip 310b representing the current location of mobile phone 200′ with respect to the visual map 202. In some embodiments, the graphical icon 310 indicates not only the position of mobile phone 200′ but also the orientation (i.e., the position of the graphical icon representing the position of mobile phone 200′, the orientation of the graphical icon representing the orientation of mobile phone 200′). Thus, the user of mobile phone 200′ is shown to be located at the tip 310b of graphical icon 310 and is shown to be oriented (i.e., holding his mobile phone in such a way) such that he is facing in the direction in which the pointed end 310a is aimed.

Thus, as shown in FIG. 3A, the user of mobile phone 200 is provided with a graphical display upon the screen 201 of his phone that indicates useful information as follows. The user is provided with a graphical indication of his or her own location at 204 with respect to other features displayed within visual map 202. The user is provided with a visual map 202 of his local environment with the size, position, and orientation of the displayed visual map 202 being automatically selected by circuitry supported by mobile phone 200 as follows. The position and orientation of the visual map 202 is selected such that it is correct relative to graphical icon 204 that represents the location and orientation of the user of the mobile phone 200 with respect to the real physical world. In other words, the visual map 202 shows the real physical word at an orientation that is consistent with the user of the mobile phone 200 facing the direction represented by arrow 204 and is consistent with the user being located within the physical world at a position represented by the tip of arrow 204. Thus, the image presented via the visual map 202 represents the physical world such that the current GPS location of the user in that it corresponds with the location within the visual map 202 that is substantially at or near the tip of arrow 204 and the orientation of the image presented via the visual map 202 is such that the direction that a user would be looking (i.e., if facing in the direction of arrow 204) lies vertically above the displayed arrow 204. In this way, a user holding mobile phone 200 can view the portion of the physical world that is directly ahead of him as the portion of the graphically displayed map that lies above the arrow 204.

According to numerous embodiments of the present invention, circuitry supported by the mobile phone 200 is adapted to automatically display a visual map 202 that depicts the local environment from the correct position and orientation, but there is one more variable that may be controlled in the display of the visual map 202—the scale of the image (i.e., how much of the local environment is to be displayed upon the screen). The image could be displayed with a scale, for example, that shows approximately 25 square miles of the local environment. Or it could be chosen such that is shows approximately 2500 square feet of the local environment. In fact, the scale of the image could vary from very large (e.g., showing most of the state of California that the user is standing in) to very small (e.g., showing a fifty square foot region of Disney Land that is directly in front of the user). The meeting locator system and associated methods automatically select the scaling of the displayed image based upon the computed distance between mobile phone 200 and mobile phone 200′. These methods are highly beneficial because it provides exactly the scale of mapping information that the user needs in order to find an intervening meeting location between himself and the user of mobile phone 200′. Thus, the scale of visual map 202 is selected by the circuitry based upon the computed spatial distance between mobile phone 200 and mobile phone 200′, derived by performing a mathematical operation upon the GPS locations of each. In this particular embodiment, the scale of the visual map 202 is computed such that the vertical distance displayed upon the visual map 202 (i.e. the real-world distance represented between the bottom of the screen image and the top of the screen image) is approximately 15% larger than distance between mobile phone 200 and mobile phone 200′. This provides the user with a view of the local environment that is scaled such his own location and the location of the user of mobile phone 200′ can both be represented within the image (at this set scale) with a small amount of additional image being displayed around that range for context. This is likely to be the scale of information that the user desires when trying to meet up with the user of mobile phone 200′.

In some embodiments, the user may be provided with a user interface function to manually override the automatic image scaling feature. For example the user may wish to momentarily zoom out or zoom in so as to view certain locative information from the visual geospatial mapping imagery. In such embodiments, the user may engage an interface control, for example a scroll wheel, and selectively zoom in or zoom out upon the displayed geospatial imagery. In such embodiments, the user is generally provided with a user interface function to quickly switch back to the automatic scaling provided by the circuitry.

According to numerous embodiments, circuitry supported by the mobile phone 200 is adapted to display, via the screen 201, the GPS location of mobile phone 200′ (i.e., the phone that the user is currently engaged in a real-time voice conversation with in order to find a meeting location). This location is displayed by icon 310 which is overlaid upon the appropriately scaled image of the visual map 202. The displayed location of icon 310 with respect to the displayed visual map 202 indicates the location of mobile phone 200′ within the local environment represented by the visual map 202. In some embodiments, the displayed orientation of the icon 310 with respect to the visual map 202 indicates the orientation of the mobile phone within the local environment. In this way, the user of mobile phone 200 is provided with a single visual representation that represents a map of his local environment 202, his own physical location within that environment 204, and the location of the user he is currently engaged in a conversation with 310. In addition, the orientation of the user of phone 200′ may also be displayed.

In orientation-based embodiments such as those described above, mobile phone 200 may receive orientation data from mobile phone 200′ along with the position data. This can be achieved by collecting locative data from a GPS sensor and orientation data from a magnetometer. Thus, mobile phone 200′ collects locative data from its GPS sensor, orientation data from its magnetometer, and sends both the locative and orientation data to mobile phone 200′. Mobile phone 200 would send the same information to mobile phone 200′ if that phone was configured to display orientation of the distant phone as well.

According to numerous embodiments, circuitry supported by the mobile phone 200 may be adapted to determine a travel path between the users and display the travel path to the user in a certain format, either automatically or as a result of the user selecting a particular display option from the manual user interface of the mobile phone. For example, the circuitry may be adapted to geometrically determine (i.e., identify) a line segment between the users and cause the line segment to be drawn over the visual map 202, wherein the line segment connects the location of mobile phone 200 with the location of mobile phone 200′. An example of such an overlaid line segment is shown in FIG. 3A as element 312a. As shown, the line segment 312a is determined considering only the relative locations of the users of the mobile phones 200 and 200′. This line segment 312a is useful for the user for it represents the most direct route (i.e., travel path) between the two users and it may therefore assist the user in visually planning a meeting location that lies between the two users. Also, the circuitry may be adapted to cause a graphical indication of the spatial midpoint between the two users to be drawn upon the corresponding location upon the visual map 202. In this example, the midpoint is represented as a small tick-line crossing the line segment as shown at 315a. In other embodiments, the midpoint may be represented by other graphical indicators. In the illustrated embodiment, the midpoint location 315a represents the geometric center between the user of mobile phone 200 and the user of mobile phone 200′. This location is likely to be at or near a convenient meeting location for the two users for if the users both travel at a similar speed; this location is likely to be at or near where the users will encounter each other if they travel towards each other. Such a midpoint location is efficient for it will likely result in both users reaching the meeting location at substantially the same time (assuming they travel at similar speeds) without one user standing around waiting for very long.

As will be described in greater detail below, the midpoint location as well as the location of the other graphical overlays is repeatedly updated as the users walk towards each other. Therefore, if it turns out that one user is slower than the other user, the midpoint location will be adjusted accordingly, continually guiding the users towards an updated meeting location that represents an intelligent meeting target. Thus, because the midpoint location will be continually updated over time based upon the progress made by the users as they head towards each other, it will shift over time to account for differences in user travel speed towards each other and continually guide the users towards the updated midpoint between them. This is useful because the users can just head towards the midpoint, knowing it will change over time based upon user progress, always guiding the users towards the halfway point between them.

Referring still to FIG. 3A, also displayed upon the screen is textual information as shown at 330. This textual information includes a numerical representation of the distance between mobile phone 200 and mobile phone 200′. Accordingly, the distance between mobile phones 200 and 200′ is the length of the displayed travel path (i.e., line segment 312a). As shown in FIG. 3A, this distance is presented as 3230 ft. This information may be useful in helping the user to judge how far away the user of mobile phone 200′ is from his current location.

In some embodiments, additional information is provided at 330, including an estimated time until the users will meet, assuming they immediately begin traveling towards each other along the travel path (i.e., line segment 312a). As shown in FIG. 3A, this estimated travel time is shown to be 5.6 minutes. To estimate the time until the users will meet, assuming the users immediately begin traveling towards each other (i.e., the estimated travel time), circuitry supported by the mobile phone 200 is adapted to predict the average velocity for each user as well as estimate the distance between the users of the mobile phones 200 and 200′. Both the travel time and the total distance can be estimated or computed by circuitry supported by the mobile phone 200 in a number of ways.

Generally, the estimated travel time is computed based upon a predicted average travel speed for the users divided by the distance between them. This may be a simple computation using a single average speed for each user, or may be a more slightly complex computation that uses a different average speed for each user.

In one embodiment, the estimated travel time (Tₑₛₜᵢₘₐₜₑ) can be computed as the total distance between mobile phone 200 and mobile phone 200′ (Dₜₒₜₐₗ) divided by twice the average predicted speed for both users (S_{average}). This computation is shown as follows:
Tₑₛₜᵢₘₐₜₑ=Dₜₒₜₐₗ/(2×S_{average})

In another embodiment, the estimated travel time (Tₑₛₜᵢₘₐₜₑ) can be computed as the total distance between mobile phone 200 and mobile phone 200′ (Dₜₒₜₐₗ) divided by the sum of the average predicted speed for the user of mobile phone 200 (S1_{average}) and the average predicted speed for the user of mobile phone 200′ (S2_{average}). This computation is shown as follows:
Tₑₛₜᵢₘₐₜₑ=Dₜₒₜₐₗ/(S1_{average}+S2_{average})

The above computations assume that the users are moving substantially towards each other along the travel path that covers distance Dₜₒₜₐₗ. Dₜₒₜₐₗ may be calculated or estimated in many ways. In one embodiment, Dₜₒₜₐₗ may be estimated simply as the linear distance between the GPS coordinate for mobile phone 200 and the GPS coordinate for mobile phone 200′. In another embodiment, it is assumed that the users will not be able to travel a straight line between these to points and will increase the estimated distance by some correction factor. For example, Dtotal may be computed as 125% of the distance between the GPS coordinate for mobile phone 200 and the GPS coordinate for mobile phone 200′ to account for the added travel distance with a rough estimate. In another embodiment, the visual map 202 may include the spatial locations of roads and paths that lie in the intervening distance between mobile phone 200 and 200′ and it may be assumed that the users will use these roads and paths. In such embodiments, Dₜₒₜₐₗ is computed as the shortened linear distance of usable roads and paths that lie between mobile phone 200 and mobile phone 200′. Therefore, in the embodiments described above, the value of Dₜₒₜₐₗ is estimated based, at least in part, upon the travel path.

The average speed S_{average} and/or the average speeds S1_{average} and S2_{average} (collectively referred to as “average speeds”) may be computed or estimated in many ways. In one embodiment, the average speeds are computed based upon a predicted average speed for the user based upon his or her mode of travel. If the user is on foot, a predicted average speed may be selected (e.g., as 5 feet per second). If the user is on a bicycle, a different predicted average speed may be selected (e.g., 25 feet per second). If the user is driving a car, a different predicted average speed may be selected (e.g., 45 feet per second). Such a process requires that the circuitry supported by the mobile phone 200 be informed of the mode of travel of the user. In a typical embodiment, circuitry supported by the mobile phone 200 assumes the user is on foot unless the user specifies otherwise. The mode of travel may be indicated by a mode-of-travel icon 335 upon the display screen 201. As shown, the mode-of-travel icon 335 indicates that the user is currently in a walking mode of travel. Other modes of travel may be specified by the user including jogging, bicycle riding, and driving modes of travel. Generally, these modes of travel may be specified by selecting an option from the manual user interface 208. Nevertheless, some embodiments may only support a walking mode of travel.

In another embodiment, the average speeds may be computed based, at least in part, upon a current speed of the users of mobile phone 200 and 200′. In another embodiment, the average speeds may be computed based, at least in part, upon one or more historical speed values stored for the users of mobile phone 200 and 200′. In this way, the average speed of each or both users may be computed based upon the current speed and/or the historical speed values recorded for those users.

In other embodiments, the estimated travel time (Tₑₛₜᵢₘₐₜₑ) may be computed or estimated by considering additional factors such as current traffic conditions, weather conditions, construction condition (e.g., indicating the construction activity on the path/road the user is traveling upon), a terrain condition (e.g., indicating the presence of hills, the type of terrain the user is moving over, etc.), or other factors that may slow the users' progress towards each other, or combinations thereof (collectively referred to herein as “travel conditions”). An exemplary use of such factors is disclosed in pending U.S. Patent Application Publication No. 2005/0227712, which is hereby incorporated by reference. According to numerous embodiments, coefficients of these travel conditions (i.e., travel condition coefficients) may be employed in the embodiments described herein to adjust Tₑₛₜᵢₘₐₜₑ so as to increase the accuracy of Tₑₛₜᵢₘₐₜₑ.

For example, the estimated travel time (Tₑₛₜᵢₘₐₜₑ) may be adjusted based upon a traffic condition factor that is computed based upon the predicted traffic conditions (e.g., pedestrian or vehicle). For example, if it is known that Disney Land is very crowded at the current time Tₑₛₜᵢₘₐₜₑ, computed for the example user shown in FIG. 3A, may be computed as follows with the value of a traffic condition coefficient C_{traffic} between 1.00 and 1.50.
Tₑₛₜᵢₘₐₜₑ=(Dₜₒₜₐₗ/(S1_{average}+S2_{average}))*C_{traffic}

The value of C_{traffic} may determined based upon the current traffic level in the environment local to the user. In this example, the user is on foot so the traffic coefficient refers to pedestrian traffic. At the current time, the user is in Disney Land and it is very crowded so the traffic coefficient is set to 1.45. The value of C_{traffic} may be computed based upon data input by the user or may be computed by accessing a remote server (e.g., the locative server 100) that provides up-to-date traffic information for various environments based upon the location of the user. In the example in which the user enters the data, the user may select a traffic condition setting from a menu on the user interface. For example, the user may select “Heavy Traffic” on the menu upon his mobile phone 200 to indicate that he or she is currently within a heavy traffic condition. Or the user may select a value between, for example, 1.00 to 1.50 that reflects the user's perception of the current traffic level. In another embodiment, the locative server 100 stores traffic information (based upon sensor readings) from a plurality of locations and stores those traffic values based upon GPS location. The mobile phone accesses this server, provides a current GPS location for the mobile phone, and thereby accesses the traffic conditions for that location. In this way, Tₑₛₜᵢₘₐₜₑ may be computed by considering the traffic levels in the intervening area between the user of mobile phone 200 and mobile phone 200′.

Similar to the traffic condition coefficient C_{traffic}, a weather condition coefficient C_{weather} may be used to adjust Tₑₛₜᵢₘₐₜₑ based upon rain, snow, ice, fog, sun, or other weather conditions that may increase or otherwise affect the estimated travel time Tₑₛₜᵢₘₐₜₑ. An example equation may be as follows:
Tₑₛₜᵢₘₐₜₑ=(Dₜₒₜₐₗ/(S1_{average}+S2_{average}))*C_{weather}

The value of C_{weather} may be determined based upon the current weather conditions in the environment local to the user. For example, if it is currently sunny and clear, the value of C_{weather} may be set to 1.0. Accordingly, C_{weather} will not increase the estimated travel time Tₑₛₜᵢₘₐₜₑ. The value for C_{weather} may be computed based upon data input by the user or may be computed by accessing a remote server (e.g., the locative server 100) that provides up-to-date weather information for various environments based upon the location of the user. In the example in which the user enters the data, the user may select a weather condition setting from a menu on the user interface. For example, the user may select “Sunny” on the menu upon his mobile phone to indicate that it is currently sunny at his or her current location. Alternately, the user may have selected rainy, snowy, icy, foggy, or some other weather condition that, in the user's perception, might slow his or her travel. Such weather conditions are translated by circuitry supported by the mobile phone 200 into a value of C_{weather} that is greater than 1.0. In another embodiment, the mobile phone accesses weather information based upon GPS location from a remote server. The mobile phone access this server, provides a current GPS location for the mobile phone, and thereby accesses the weather conditions for that location. In this way, Tₑₛₜᵢₘₐₜₑ may be computed with consideration for the weather conditions in the intervening area between the user of mobile phone 200 and mobile phone 200′. Similar travel condition coefficients may be used for terrain conditions such as hills, muddy ground, or rough roads.

As discussed above, Tₑₛₜᵢₘₐₜₑ may be adjusted based upon individual consideration of travel condition coefficients. It will be appreciated, however, that Tₑₛₜᵢₘₐₜₑ may be adjusted based upon an aggregate consideration of travel condition coefficients as follows:
Tₑₛₜᵢₘₐₜₑ=(Dₜₒₜₐₗ/(S1_{average}+S2_{average}))*C_{traffic}*C_{weather}

As exemplarily illustrated above, each travel condition coefficient is given the same weight in adjusting Tₑₛₜᵢₘₐₜₑ. It will be appreciated, however, that each travel condition coefficient may be weighted differently in adjusting Tₑₛₜᵢₘₐₜₑ.

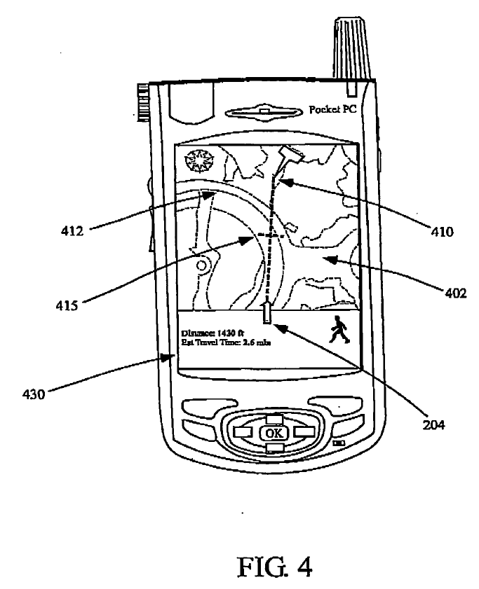

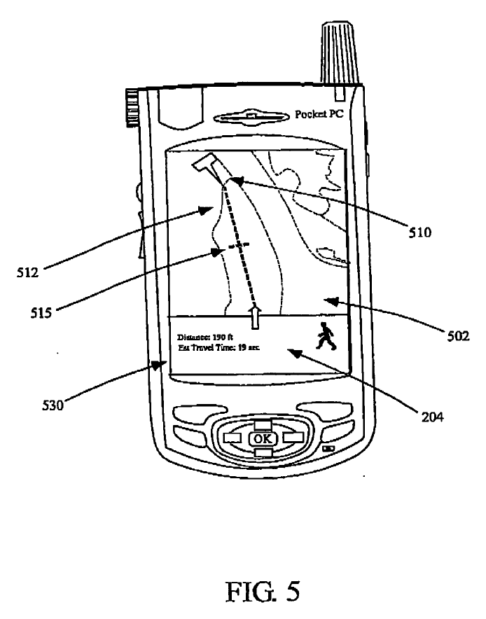

Referring still to FIG. 3A, the image shown is based upon the current locative values determined by sensors on board mobile phone 200 and mobile phone 200′ as described previously. In one embodiment, the screen 201 is updated regularly based upon updated sensor values. For example, as either or both mobile phones (200 and 200′) change their location within the real physical world, the display is updated. This includes updating the position and/or orientation of the displayed visual map 202. This includes updating the displayed position and/or orientation of the displayed icon 310 that represents mobile phone 200′ upon the corresponding location on the visual map 202. This also includes updating the displayed location of the line segment 312a. This also includes updating the displayed location of the midpoint graphic 315a. This also includes computing an updated distance between mobile phone 200 and 200′ and updating the numerical value for distance shown in 330. This also includes computing an updated estimated travel time for the users to meet each other and updating the display of this meeting time at 330. This also includes updating the scaling of the displayed visual map 202. In one embodiment, the scaling is adjusted based upon the distance between mobile phone 200 and 200′. Thus, as the users approach each other, the scaling is “zoomed in” to display smaller and smaller spatial areas upon the display. The other overlaid images (for example 310, 312a, and 315a) are all adjusted accordingly so they continue to correspond with the correct portion of the visual map 202. The adjusted scaling will be described in more detail with respect to FIGS. 4 and 5 to follow which show how the image may change its scale automatically as the users approach each other.

As described previously, FIG. 3A illustrates one exemplary embodiment in which a line segment 312a based upon the shortest distance between mobile phone 200 and 200′ is displayed. While such a displayed line segment may be useful, in many situations the user's motion may be restricted to a set of known roads and/or paths. Often, circuitry supported by the mobile phone 200 has access to the location and definition of these roads and paths as part of the geospatial dataset for the environment local to the user. Using these definitions, circuitry supported by the mobile phone 200, in one embodiment, is adapted to determine a travel path between mobile phone 200 and mobile phone 200′ that is not a straight line segment, but is simply the shortest travel path available upon intervening roads and paths between the users. Accordingly, circuitry supported by the mobile phone 200 is adapted to geographically determine a travel path. An example of such a geographically determined travel path is shown with respect to FIG. 3B.

As shown in FIG. 3B, an overlaid, geographically determined travel path 312b is displayed upon the visual map 202, the graphical line indicating the shortest travel path between mobile phone 200 and mobile phone 200′ along intervening roads and/or paths. As shown, the graphical line 312b is determined considering not only the relative locations of the users of the mobile phones 200 and 200′, but also a combination of roads and/or paths (i.e., geographical features) that is part of the environment local to the users of mobile phones 200 and 200′. This graphical line 312b is useful for the users to see for it represents the likely path that both users will travel when heading towards each other. Also shown in FIG. 3B is an overlaid midpoint graphical indicator 315b. This graphical indicator is drawn at the midpoint of the distance along the length of line 312b thereby indicating the geographic midpoint of the likely path of travel that the users will take towards each other rather than the geometric midpoint between the users. In this example, the geographic midpoint is represented as a small circle as shown at 315b. In other embodiments, other graphical indicators may be used.

Also displayed upon the screen is textual information as shown at 330. This textual information includes a numerical representation of the distance between mobile phone 200 and mobile phone 200′. Accordingly, the distance between mobile phones 200 and 200′ is the length of the displayed travel path (i.e., graphical line 312b). As shown in FIG. 3B, this distance is presented as 3630 ft. In some embodiments, additional information is provided at 330, including an estimated time until the users will meet, assuming they immediately begin traveling towards each other along the travel path (i.e., graphical line 312b). As shown in FIG. 3B, this estimated travel time is shown to be 6.3 minutes. Such information may be useful in helping the user to judge how far away the user of mobile phone 200′ is from his current location and/or how much time it will take before the two users meet.

Thus, the graphical line 312b is useful for the user for it represents the most likely route between the two users and it may therefore assist the user in visually planning a meeting location that lies between the two users. Also, the graphical indication of the geographic midpoint 315b of the plotted path between the two users is useful to the user because it represents the geographic center point between the user and the user of mobile phone 200′. This location is likely to be at or near a convenient meeting location for the two users for if the users both travel at a similar speed; this location is likely to be at or near where they will encounter each other if they travel towards each other. Such a location is efficient for it will likely result in both users reaching the meeting location at substantially the same time (assuming they travel at similar speeds) without one user standing around waiting for very long.

According to many embodiments, the location of the geographic midpoint 315b upon visual map 202 may be repeatedly updated as the users walk towards each other so if it turns out that one user is slower than another, the midpoint location will adjust accordingly, continually guiding the users towards an updated central meeting location between them. Thus, because the midpoint location will be continually updated over time based upon the progress made by the users as they head towards each other, shifting over time to account for differences in user travel speed towards each other and continually guide the users towards the updated midpoint between them. This may be useful because the users can just head towards the midpoint, knowing it will change over time based upon user progress, always guiding the users towards the halfway point between them.

As described above, circuitry supported by the mobile phone 200 may be adapted to compute and display the geometric midpoint 315a exemplarily shown in FIG. 3A, representing the geometric center between the users, or the geographic midpoint 315b exemplarily shown in FIG. 3B, representing the geographic center of the likely travel path (based upon intervening roads and paths) that the users are predicted to travel as they head towards each other. In another embodiment, however, circuitry supported by the mobile phone 200 may be adapted to adjust the location of the midpoint 315a or 315b along either line segment 312a or graphical line 312b based upon, for example, the predicted travel speeds of the two users. As described previously, a predicted average travel speeds S1_{average} and S2_{average} may be computed for the user of each mobile phone 200 and 200′. If these values are different, the point at which the users are likely to meet will not be the center of the travel route between the users but will be closer to the slower of the two users based upon the ratio of the average travel speeds of the two users. Thus, the ratio of S1_{average}/S2_{average} may be used to adjust the location of the midpoint 315a or 315b along the expected travel path between the two users. In this case, the distance along the travel path from mobile phone 200 to the adjusted midpoint location can be computed based upon the average speed of the user of mobile phone 200, divided by the sum of the average speeds of both users. This is shown as follows:
D1ₑₛₜᵢₘₐₜₑ=[(Dₜₒₜₐₗ/2)*(S1_{average}/(S1_{average}+S2_{average}))]

In the equation above, D1ₑₛₜᵢₘₐₜₑ is the estimated distance away from the user of mobile phone 200 along the predicted path of travel that the users will meet at (i.e., the adjusted midpoint location). Thus, D1ₑₛₜᵢₘₐₜₑ is the length of line 312a or 312b from the user's current location to the adjusted location of midpoint 315a or 315b, respectively. Thus, based on the above equation for D1ₑₛₜᵢₘₐₜₑ, if the user of mobile phone 200 is predicted to move twice as fast as the user of mobile phone 200′, the midpoint 315a or 315b will be ⅔ of the distance from mobile phone 200 to mobile phone 200′ along the predicted travel path between the users. This location is thus displayed to the user and updated repeatedly based upon the progress of the users. If the average speeds are computed based upon current and/or historical speeds of the users, the changing speeds may thus be accounted for as this location is repeatedly updated. Thus, over time, the predicted location at which the users will meet (i.e. the travel midpoint) will get progressively more accurate.

An exemplary operation of the meeting locator system will now be discussed with respect to FIGS. 3A, 4, and 5.

As shown in FIG. 3A, two users are in communication with each other, both standing at different locations within the Disney Land amusement park. The users desire to meet up with each other physically at an intervening location between them. Thus, at a first moment in time, the users are 3230 ft apart (based upon the length of line segment 312a), the user of phone 200 receives the display as shown, and the user of phone 200′ receives a similar display, but inverted as shown from his perspective. The meeting locator system estimates that the users will meet each other in 5.6 minutes (as displayed at 330) based upon an exemplary estimation of the users' average speeds towards each other.

As the users begin walking towards each other along the intervening paths between them in the Disney Land amusement park, the computations and displayed images are updated (e.g., regularly based upon the GPS locations of each user). At a second moment in time, subsequent to the first moment in time, the users are at new locations and an image displayed upon the mobile phone 200 is presented as exemplarily shown in FIG. 4. As shown, the two users are now closer together. Because the distance between them is computed to be smaller, the visual map 402 is displayed with a higher degree of zoom as described previously. Thus, the visual map 402 shows a smaller physical area of the Disney Land amusement park than visual map 202. As before, the location of the user of phone 200 is shown by arrow 204. As before, the location of the user of phone 200′ is shown by icon 410. This location has been updated based upon the new locative data from that phone and the new scaling of the visual map 402. In some embodiments, the orientation of the icon can be updated based upon orientation data received from mobile phone 200′. Also, a newly computed line segment 412 is shown upon the screen. Also, a newly computed midpoint 415 is shown upon the screen. In addition, the numerical values for the distance between the users and the estimated time until they meet are updated and displayed at 430. As exemplarily shown, the users are now 1430 ft apart and it is estimated that they will meet each other physically in 2.6 min.

As the users continue walking towards each other along the intervening paths between them in the Disney Land amusement park, the computations and displayed images are updated (e.g., regularly based upon the GPS locations of each user). At a third moment in time, subsequent to the second moment in time, the users are at new locations and an image displayed upon the mobile phone 200 is presented as exemplarily shown in FIG. 5. As shown, the two users are now even closer together than before. Because the distance between them is computed to be smaller, the visual map 502 is displayed with an even higher degree of zoom as described previously. Thus, the visual map 502 shows an even smaller physical area of the Disney Land park than visual map 402. As before, the location of the user of phone 200 is shown by arrow 204. As before, the location of the user of phone 200′ is shown by icon 510. This location has been updated based upon the new locative data from that phone and the new scaling of the visual map 502. In some embodiments, the orientation of the icon will also be updated based upon orientation data received from mobile phone 200′. Also, a newly computed line segment 512 is shown upon the screen. Also, a newly computed midpoint 515 is shown upon the screen. In addition, the numerical values for the distance between the users and the estimated time until they meet are updated and displayed at 530. As exemplarily shown, the users are now 190 ft apart and it is estimated that they will meet each other physically in 19 seconds.

Based upon the exemplary operation of the meeting locator system as described with respect to FIGS. 3A, 4, and 5, even if the park is extremely crowded, and even if the users can not see each other, they both know they are getting very near to each other and can estimate the amount of time it will take for them to reach each other and meet physically. The information presented upon the display screen 201 will continue to be updated repeatedly until the users meet each other.

In some embodiments, the meeting locator system will automatically terminate (e.g., the mobile phones 200 and 200′ will cease accessing locative data, will cease displaying information upon the display screen 201, or the like, or combinations thereof) if it determines that the users are within a certain minimum distance of each other for a certain threshold amount of time. For example, the meeting locator system will automatically terminate if it determines that the users are within 10 feet of each other for more than 30 seconds.

In some embodiments, an alert may be presented to the users when they come within a certain proximity of each other (e.g., 20 feet), the alert being visual, audio, and/or tactile in form. The alert is useful in helping to ensure that the users do not walk past and miss each other.

In some embodiments, an alarm may be presented to the user if circuitry supported by the mobile phone 200 determines that the users have missed each other. This alarm may be visual, audio, and/or tactile in nature. The alarm may be, for example, a beeping sound that indicates that the users have missed each other. Circuitry supported by the mobile phone may be configured to determine that the users missed each other if they come within some minimum distance of each other and the distance between them is then determined to be increasing for more than some threshold amount of time. Alternately, circuitry supported by the mobile phone may be configured to determine that the user's missed each other only if the distance between them begins increasing for more than some threshold amount of time. Alternately, circuitry supported by the mobile phone may be configured to determine that the user's missed each other only if the distance between them is determined to be increasing over any amount of time. Thus, in a particular embodiment, circuitry supported by the mobile phone 200 may be adapted to impart an alert to the users when they come within a certain distance of each other (e.g., 20 feet). This alert informs the user that they should be vigilant in visually spotting each other. If the users miss each other after coming within 20 feet and it is determined that the distance between them begins increasing for more than 5 seconds, an alarm is sounded indicating the miss. In this way, it is highly unlikely that the users will get too far away from each other without turning around finding each other.

Although not shown in the figures, the users may optionally wear ear pieces and/or other components that provide audio display directly to their ears and/or provides a microphone function closer to their mouths. For example, a wireless ear piece with microphone capability may be used in conjunction with the mobile phone described herein, the wireless ear piece optionally being connected by Bluetooth to the phone unit. Such a configuration may be beneficial for it allows a user to talk on the phone conveniently while holding the display portion of the phone in a location that is easy to view. In alternate embodiments, a headset is worn by the user, the headset including audio, microphone, and/or visual display capabilities. In addition, the meeting locator system may be operative to function in response to voice commands and/or other user input methods. For embodiments which include a headset or other external component that includes display capabilities, locative and/or orientation sensors may be incorporated within and/or upon such external components. In this way, the configuration and/or orientation of displayed imagery may be responsive to the location and/or orientation of the headset and/or other external component.

While the embodiments exemplarily described herein have been described by means of specific examples and applications thereof, numerous modifications and variations could be made thereto by those skilled in the art without departing from the scope of the invention set forth in the claims.

What is claimed is:

1. A meeting location method, comprising:
accessing current locative data of a first mobile unit and a second mobile unit, the locative data representing the location of each of the first and second mobile units;
computing a midpoint location between the location of the first and second mobile units as represented by the current locative data of the first and second mobile units;
accessing a database containing a visual map showing an environment local to both the first and second mobile units; and
displaying, upon a screen of at least one of the first and second mobile units, the accessed visual map, a first icon representing the location of the first mobile unit with respect to the accessed visual map, a second icon representing the location of the second mobile unit with respect to the accessed visual map, and the midpoint location.

2. The meeting location method of claim 1, wherein the midpoint location is the geographic midpoint between the location of the first and second mobile units.

3. The meeting location method of claim 1, wherein the midpoint location is determined with consideration of a speed of travel of both said first mobile unit and said second mobile unit, the midpoint location indicating an expected approximate meeting location of the first and second mobile units based upon the speed of travel of each.

4. The meeting location method of claim 1, wherein the midpoint location is a midpoint upon at least one of a determined path of travel along at least one of designated roads and paths between the first and second mobile units.

5. The meeting location method of claim 1, wherein the midpoint location is updated repeatedly based at least in part upon changes in location of at least one of the first and second mobile units.

6. The meeting location method of claim 1, wherein the first icon represents an orientation of the first mobile unit with respect to the accessed visual map.

7. The meeting location method of claim 1, wherein the second icon represents an orientation of the second mobile unit with respect to the accessed visual map.

8. The meeting location method of claim 1, further comprising:
determining a distance between the location of the first and second mobile units as represented by the current locative data of the first and second mobile units; and
scaling the accessed visual map based upon the determined distance.

9. The meeting location method of claim 1, further comprising:
determining a travel path between the between the location of the first and second mobile units as represented by the current locative data of the first and second mobile units; and
displaying the travel path over the visual map upon the screen of at least one of the first and second mobile units,
the travel path being upon one or more designated roads or paths between the first and second mobile units.

10. The meeting location method of claim 9, further comprising:
computing a distance between the first and second mobile units based upon the determined travel path; and
displaying a numerical representation of the computed distance upon the screen of at least one of the first and second mobile units.

11. The meeting location method of claim 10, further comprising:
computing an estimating travel time based upon the computed distance, the estimated travel time indicating an amount of time that will pass until the first and second mobile units will meet each other at the midpoint location while traveling along the determined travel path; and
displaying a numerical representation of the estimated travel time upon the screen of at least one of the first and second mobile units.

12. The meeting location method of claim 11, further comprising:
determining a speed for both the first and second mobile units; and
computing the estimated travel time based upon the speeds determined.

13. The meeting location method of claim 11, further comprising computing the estimated travel time based upon at least one of a traffic condition, a weather condition, a construction condition, and a terrain condition.

14. The meeting location method of claim 9, further comprising determining the travel path based upon the locations of the first and second mobile units as represented by the current locative data of the first and second mobile units.

15. The meeting location method of claim 14, further comprising determining the travel path based upon geographical features of the environment local to both the first and second mobile units.

16. The meeting location method of claim 1, further comprising:
determining a speed for both the first and second mobile units; and
adjusting the computed midpoint location based upon the speeds determined.

17. The meeting location method of claim 1, further comprising:
determining whether a distance between the first and second mobile units is below a threshold distance; and
generating a user alert on at least one of the first and second mobile units when the distance between the first and second mobile units is below the threshold distance, the user alert adapted to indicate that the first and second mobile units are within a certain proximity to each other.

18. The meeting location method of claim 1, further comprising:
determining whether a distance between the first and second mobile units is below a threshold distance for a threshold amount of time; and
ceasing to access current locative data of the first and second mobile units when the distance between the first and second mobile units is below the threshold distance for more than a threshold amount of time.

19. The meeting location method of claim 1, further comprising:
determining whether a distance between the first and second mobile units is below a threshold distance at a first time and is above the threshold distance at a second time subsequent to the first time; and
generating an alarm at at least one of the first and second mobile units when the distance between the first and second mobile units is below the threshold distance at the first time and is above the threshold distance at the second time, the alarm adapted to indicate that users of the first and second mobile units have missed each other.

20. A meeting locator system, comprising:
first and second mobile units each adapted to generate locative data representing its location, wherein at least one of the first and second mobile units comprises:
a display screen; and
circuitry adapted to:
access current locative data of the first mobile unit and the second mobile unit;
compute a midpoint location between the location of the first and second mobile units as represented by the current locative data of the first and second mobile units;
access a database containing a visual map showing an environment local to both the first and second mobile units; and
display, upon the display screen, the accessed visual map, a first icon representing the location of the first mobile unit with respect to the accessed visual map, a second icon representing the location of the second mobile unit with respect to the accessed visual map, and the midpoint location.

21. The meeting locator system of claim 20, wherein the midpoint location is the geographic midpoint between the location of the first and second mobile units.

22. The meeting locator system of claim 20, wherein the circuitry is adapted to determine midpoint location with consideration of a speed of travel of both said first mobile unit and said second mobile unit, the midpoint location indicating an expected approximate meeting location of the first and second mobile units based upon the speed of travel of each.

23. The meeting locator system of claim 20, wherein the midpoint location is a midpoint upon at least one of a determined path of travel along at least one of designated roads and paths between the first and second mobile units.

24. The meeting locator system of claim 20, wherein the circuitry is adapted to update the midpoint location repeatedly based at least in part upon changes in location of at least one of the first and second mobile units.

25. The meeting locator system of claim 20, wherein the first icon represents an orientation of the first mobile unit with respect to the accessed visual map.

26. The meeting locator system of claim 20, wherein the circuitry is further adapted to:
determine a distance between the location of the first and second mobile units as represented by the current locative data of the first and second mobile units; and
scale the accessed visual map based upon the determined distance.

27. The meeting locator system of claim 20, wherein the circuitry is further adapted to:
determine a travel path between the between the location of the first and second mobile units as represented by the current locative data of the first and second mobile units; and
display the travel path over the visual map upon the display screen,
the travel path being upon one or more designated roads or paths between the first and second mobile units.

28. The meeting locator system of claim 27, wherein the circuitry is further adapted to:
compute a distance between the first and second mobile units based upon the determined travel path; and
display a numerical representation of the computed distance upon the display screen.

29. The meeting locator system of claim 28, wherein the circuitry is further adapted to:
compute an estimating travel time based upon the computed distance, the estimated travel time indicating an amount of time that will pass until the first and second mobile units will meet each other at the midpoint location while traveling along the determined travel path; and
display a numerical representation of the estimated travel time upon the display screen.

30. The meeting locator system of claim 29, wherein the circuitry is further adapted to:
determine a speed for both the first and second mobile units; and
compute the estimated travel time based upon the speeds determined.

31. The meeting locator system of claim 29, wherein the circuitry is further adapted to compute the estimated travel time based upon at least one of a traffic condition, a weather condition, a construction condition, and a terrain condition.

32. The meeting locator system of claim 20, wherein the circuitry is further adapted to:
determine a speed for both the first and second mobile units; and
adjust the computed midpoint location based upon the speeds determined.

33. The meeting locator system of claim 20, further comprising:
determine whether a distance between the first and second mobile units is below a threshold distance; and
cause a user alert to be generated by at least one of the first and second mobile units when the distance between the first and second mobile units is below the threshold distance, the user alert adapted to indicate that the first and second mobile units are within a certain proximity to each other.

34. The meeting locator system of claim 20, wherein the circuitry is further adapted to:
determine whether a distance between the first and second mobile units is below a threshold distance for a threshold amount of time; and
cease to access current locative data of the first and second mobile units when the distance between the first and second mobile units is below the threshold distance for more than a threshold amount of time.

35. The meeting locator system of claim 20, wherein the circuitry is further adapted to:
determine whether a distance between the first and second mobile units is below a threshold distance at a first time and is above the threshold distance at a second time subsequent to the first time; and
cause an alarm to be generated at at least one of the first and second mobile units when the distance between the first and second mobile units is below the threshold distance at the first time and is above the threshold distance at the second time, the alarm adapted to indicate that users of the first and second mobile units have missed each other.

36. A mobile phone enabled with a meeting locator feature, the mobile phone comprising:
circuitry adapted to maintain a voice phone call between a user of the mobile phone and a user of a second mobile phone unit over a wireless link;
circuitry adapted to repeatedly receive a geospatial coordinate over a wireless link from the second mobile phone unit during a maintained voice phone call, the geospatial coordinate indicating a current location of the second mobile phone unit; and
circuitry adapted to repeatedly display during the maintained voice call, a graphical indication of the current location of the second mobile phone unit upon a displayed geospatial image, the geospatial image representing the local geographic vicinity of both the mobile phone and the second mobile phone unit.

37. The mobile phone of claim 36, further comprising circuitry adapted to repeatedly display a planned meeting location between the mobile phone and the second mobile phone unit upon the geospatial image, the planned meeting location being repeatedly dependent upon a current location of the mobile phone and the second mobile phone unit.

38. The mobile phone of claim 37, wherein the planned meeting location is at or near the geographic midpoint between the current location of the mobile phone and the second mobile phone unit.

39. The mobile phone of claim 37, wherein the planned meeting location is computed based upon the current location of the mobile phone and the second mobile phone unit, and a speed of travel of the mobile phone and the second mobile phone unit.

40. The mobile phone of claim 37, wherein the planned meeting location is determined based at least in part upon a determined path of travel between the mobile phone and the second mobile phone unit, the determined path of travel being upon at least one of designated roads and designated paths between the mobile phone and the second mobile phone unit.

41. The mobile phone of claim 36, further comprising circuitry adapted to repeatedly display an estimated travel distance between the mobile phone and the second mobile phone unit.

42. The mobile phone of claim 37, further comprising circuitry adapted to repeatedly display an estimated travel distance to the planned meeting location.

43. The mobile phone of claim 37, further comprising circuitry adapted to repeatedly display an estimated travel time to the planned meeting location, the estimated travel time being determined based at least in part upon a travel speed for the mobile phone and a travel speed for the second mobile phone unit.

44. The mobile phone of claim 36, wherein the second mobile phone unit sends updated locative values to the mobile phone upon determining that it has moved more than a threshold distance.

45. The mobile phone of claim 36, wherein the second mobile phone unit sends updated locative values at an update rate that is dependent upon the speed of travel of the second mobile phone unit.
